(19) United States
(12) Patent Application Publication
(10) Pub. No.: US 2010/0213680 A1
(43) Pub. Date: Aug. 26, 2010

(54) Convertible Scooterbag

(76) Inventors: Andrew MASSARA, Potomac Falls, VA (US); Jaron Rothkop, Royal Oak, MI (US)

Correspondence Address: Capitol City TechLaw, PLLC, PO BOX 1210, VIENNA, VA, 22183, US

(21) Appl. No.: 12/710,356

(22) Filed: Feb. 22, 2010

Related U.S. Application Data
(60) Provisional application No. 61/154,212, filed on Feb. 20, 2009.

(51) Int. Cl. B62M 1/12

(52) U.S. Cl. 280/87.041

(57) ABSTRACT

The convertible scooterbag includes a frame, a deployable deck with a rear wheel assembly, a handle assembly, front wheel assemblies and a bag assembly. The deck is attached to the frame in a manner that allows for generally pivotal movement between a stowed position and a use position, thereby allowing the scooterbag to be used in at least three different modes including a conventional wheeled bag, a stable tow-behind bag and as a scooter with an associated bag assembly or other receptacle.

### PRIORITY STATEMENT

This application claims priority under 35 U.S.C. § 119 to U.S. Prov. Pat. Appl. No. 61/154,212, filed Feb. 20, 2009, the contents of which are incorporated by reference herein, in their entirety.

### TECHNICAL FIELD

The invention relates generally to wheeled bag, and, more particularly, to a wheeled bag that is configured for conversion between various use modes including use as both a conventional wheeled bag and a steerable scooter with an associated bag assembly.

### BACKGROUND

The terms used in this document to describe the relative positioning of the various components, including, for example, upper, top, lower, bottom, back, front, forward, top, right and left are based on the typical orientation of the disclosed assembly as a scooterbag during which the user may stand on a rear deck and steer the scooter bag using one or more handles extending from a top surface.

### BRIEF SUMMARY

The scooterbag includes a primary frame, a deployable deck with a rear wheel assembly, a handle assembly, front wheel assemblies and a bag assembly. As detailed below, the deck is attached to the primary frame in a manner that allows movement between a stowed position and a use position, thereby allowing the scooterbag to be used as both a conventional wheeled bag and as a scooter with an incorporated bag assembly.

Other features and advantages inherent in the disclosed apparatus are or will become apparent to those skilled in the art after considering the following detailed description and the accompanying drawings.

### BRIEF DESCRIPTION OF THE DRAWINGS

Example embodiments of the scooterbag apparatus are addressed more fully below with reference to the attached drawings in which:

FIG. 1 illustrates a first embodiment of the scooterbag configured for use as a scooter;

FIG. 2 illustrates the first embodiment of the scooterbag configured for use as a conventional wheeled bag;

FIG. 3 illustrates portions of a second embodiment of the scooterbag configured for use as a scooter;

FIG. 4 illustrates portions of a third embodiment of the scooterbag configured for use as a conventional wheeled bag;

FIG. 5 illustrates portions of a fourth embodiment of the scooterbag configured for use as a scooter;

FIG. 6 illustrates the use of the fourth embodiment of the scooterbag as a steerable scooter;

FIG. 7 illustrates the first embodiment of the scooterbag configured for use as carry-on baggage;

FIG. 8 illustrates the first embodiment of the scooterbag configured for use as tow-behind baggage;

FIGS. 9A and 9B illustrate the transition of the third embodiment of the scooterbag from a rolling configuration through a rolling bag configuration to reach a scooter configuration, FIG. 9A, and the reverse conversion from a scooter configuration to a rolling configuration, FIG. 9B;

FIG. 10 illustrates a fifth embodiment of the scooterbag in a scooter configuration for performing both a right turn and forward motion;

FIGS. 11, 12, 13 and 14 illustrate portions of the fifth embodiment of the scooterbag and, in particular, portions of an example steering assembly as illustrated in FIG. 10;

FIG. 15 illustrates an example handle assembly that can be utilized on scooterbags including, for example, the second and fifth embodiments of the scooterbag as detailed herein; and

FIG. 16 illustrates the fifth embodiment of the scooterbag configured for use as both a scooter and as a conventional rolling bag.

It should be noted that these figures are intended to illustrate the general characteristics of methods and materials with reference to certain example embodiments of the invention and thereby supplement the detailed written description provided below. These drawings are not, however, to scale and may not precisely reflect the characteristics of any given embodiment, and should not be interpreted as defining or limiting the range of values or properties of embodiments within the scope of this invention. In particular, the relative sizing and positioning of particular elements and structures may be reduced or exaggerated for clarity. The use of similar or identical reference numbers in the various drawings is intended to indicate the presence of a similar or identical element or feature.

### DESCRIPTION OF EXAMPLE EMBODIMENTS

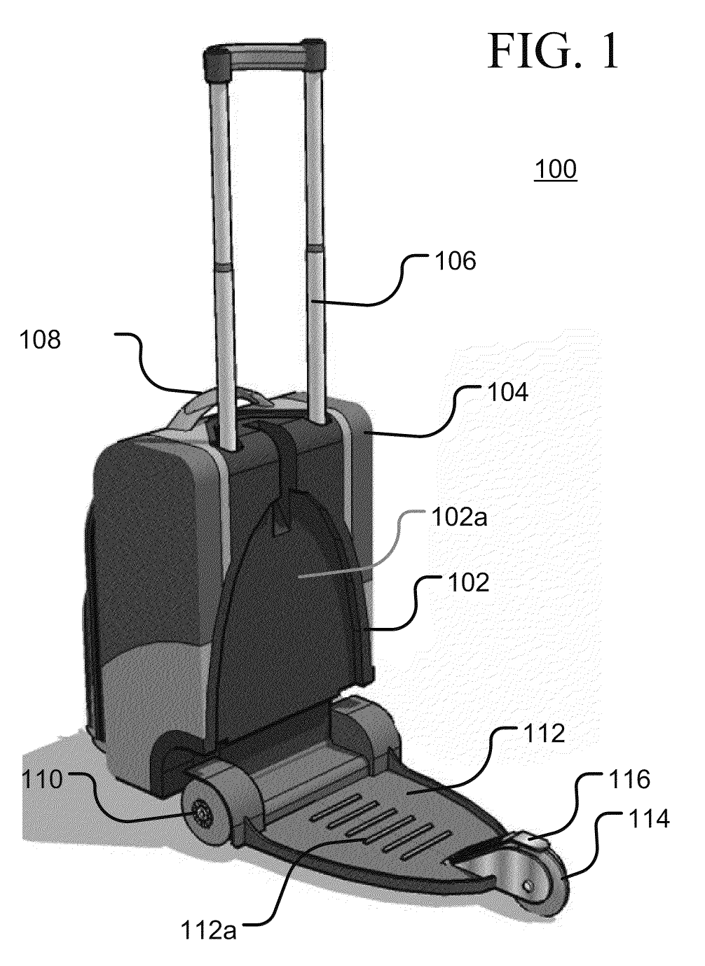

As illustrated in FIG. 1, a first embodiment of the scooterbag 100 includes a primary frame 102, a bag assembly 104, a handle assembly 106, a conventional handle 108, front wheel assemblies 110, a deck 112, a rear wheel assembly 114, and a rear break assembly 116. In FIG. 1, the scooterbag 100 is shown with the deck 112 deployed at an angle of about 90° relative to the primary frame to allow the scooterbag to be used as a steerable scooter with a front mounted bag assembly. As will be appreciated by those skilled in the art, the primary frame or armature and the deck may be manufactured from a number of materials including wood, metal and plastic and combinations thereof to meet the desired weight, strength and cost criteria. Similarly, the bag assembly may be of rigid, semi-rigid or soft-sided construction depending on the projected use and design preference.

As also illustrated in FIG. 1, the deck may be provided with surface texture or other elements 112a to provide for improved footing. A hinge structure (not shown) provided near the base of the primary frame 102 will typically include one or more ratchet and pawl or equivalent mechanisms and associated releases for selectively moving the deck 112 between, and then maintaining, desired positions including, for example, a stowed position and a deployed position, relative to the primary frame 102. It is also shown in FIG. 1, the rear wheel 114 may be provided with an associated brake assembly 116 for controlling the speed of the scooterbag when being used as a scooter. One or more auxiliary mechanisms may be provided for “locking out” the brake assembly in, for example, when the scooterbag is configured for towing or, alternatively, maintaining engagement of the brake assembly for those configurations in which it would be preferable to restrict the motion of the scooterbag including, for example, when being stowed in an overhead compartment aboard an airliner or other public conveyance.

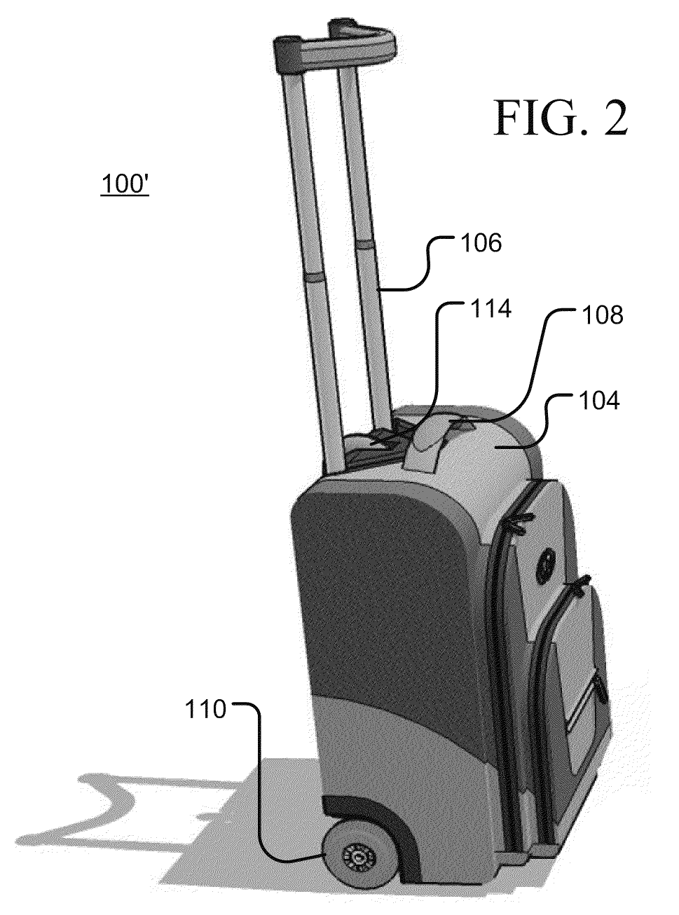

As illustrated in FIG. 2, the first embodiment of the scooterbag 100′ may be reconfigured for use as a conventional wheeled bag by returning the deck to a stowed position where it may, for example, nest in a corresponding recess 102a provided in the primary frame 102. As illustrated in FIG. 2, the rear wheel assembly 114 may still be partially exposed toward the top of the bag assembly 104.

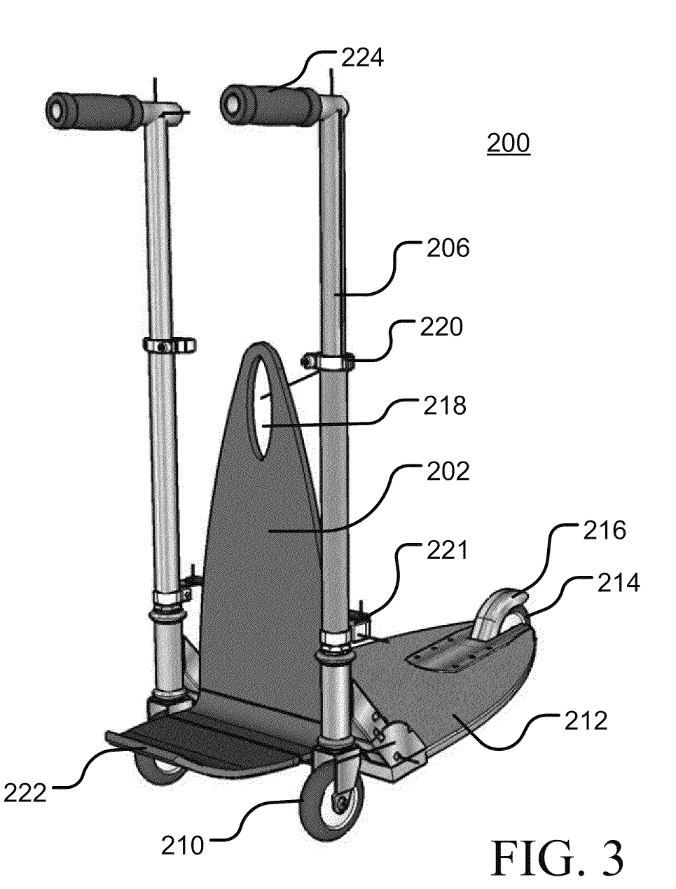

A second embodiment of the scooterbag 200 is illustrated in FIG. 3 with the bag assembly removed in order to show additional detail. As with the first embodiment, the second embodiment includes a primary frame 202, handle assemblies 206, front wheel assemblies 210, a deck 212, a rear wheel assembly 214 and a brake assembly 216. The second embodiment further includes an opening 218 for receiving a portion of the rear wheel assembly and brake assembly when the deck is in the stowed position. The handle assemblies also include locking assemblies 220 that allow for the independent adjustment of the handle assemblies. As shown, the locking assemblies allow for both height and rotational adjustment of the handle assemblies in order to improve the utility of the handles in both the scooter and wheeled bag modes. The handles 224 may include additional elements (not shown) for securing the handles in a coaxial orientation for use as a wheeled bag. As also illustrated in FIG. 3, the primary frame may include a projecting plate or support 222 that may be used for protecting and/or supporting an associated bag assembly. When utilized in a scooter configuration, the movement of the handle assemblies and front wheel assemblies can be coordinated using a linkage 221. As will be appreciated by those skilled in the art, a number of mechanisms may be utilized for achieving this functionality and, for certain embodiments, may be enclosed within the primary frame to reduce the possibility of contamination of and/or damage to the mechanism(s).

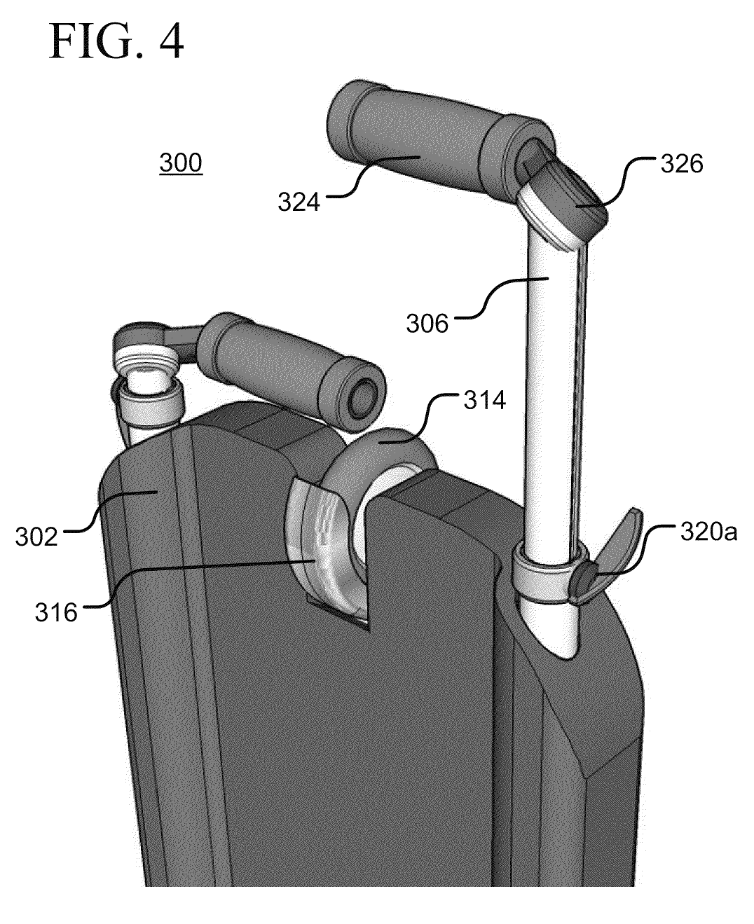

A portion of a third embodiment of the scooterbag 300 is illustrated in FIG. 4 and again includes primary frame 302, handle assemblies 306, a rear wheel assembly 314, a rear brake 316, locking assemblies 320a, a cushioned handle 324 and a handle pivot assembly 326. As will be appreciated by those skilled in the art, the handle pivot assembly and associated locking assemblies (not shown) may be used to provide a wider array of handle positions for improving the comfort and/or safety for a wider range of customers and uses.

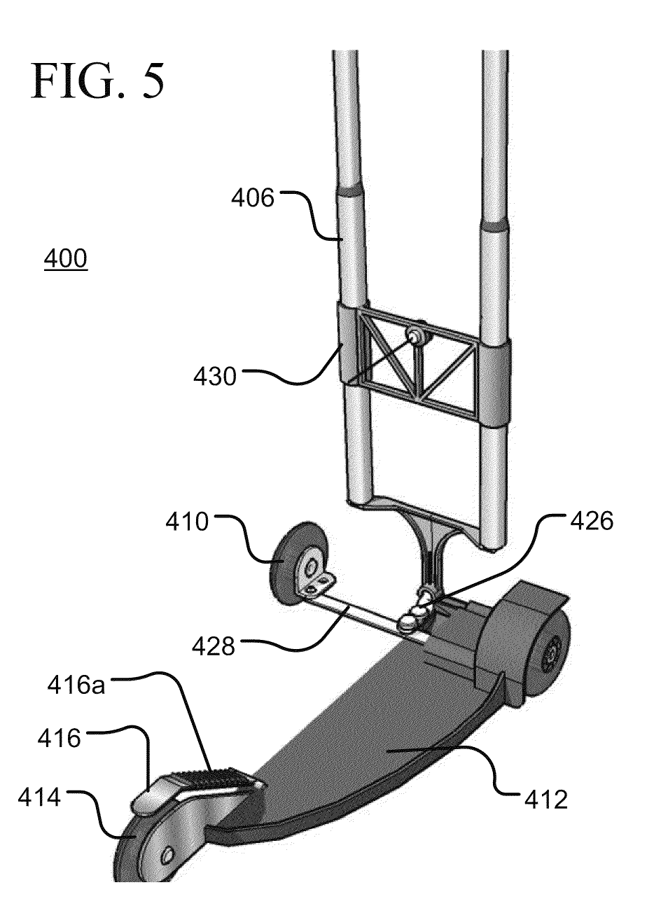

A portion of a fourth embodiment of the scooterbag 400 is illustrated in FIG. 5 with the bag assembly, the primary frame and a portion of the deck removed for clarity. As illustrated, the structure includes handle assemblies 406, the deck 412 (partially shown) the front wheel assemblies 410, the rear wheel assembly 414, the rear brake assembly 416, a textured surface provided on the break assembly 416a for improving traction, a pivot assembly 426, a steering linkage 428 and a reinforcing subassembly 430 associated with the handle assembly. As will be appreciated by those skilled in the art, the linkage and the pivot assembly, or equivalent structures, may be used in cooperation to transfer steering input from the handles to the front wheels and to synchronize their motion. Additional structures (not shown) may be provided on the primary frame and/or the deck for limiting or preventing off axis movement of the front wheels when the scooterbag is configured for use as a conventional rolling bag.

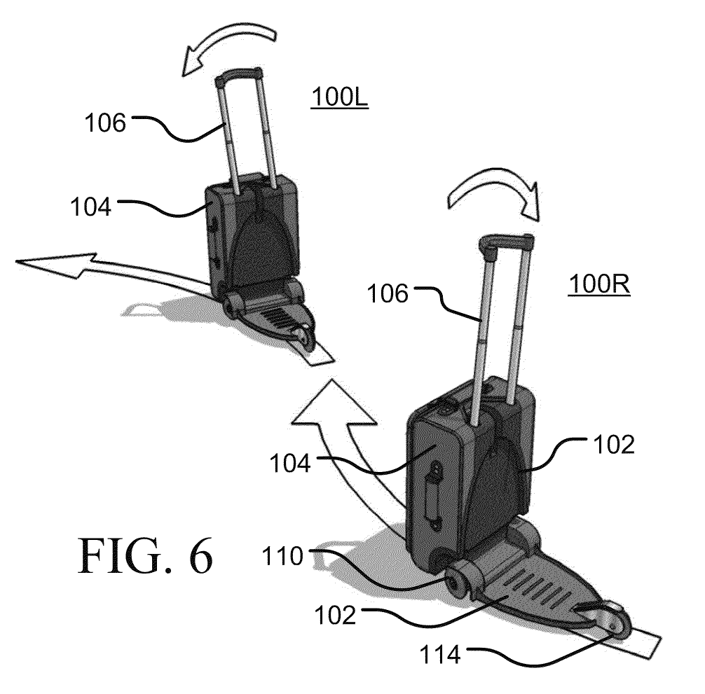

Operation of the scooterbag configured for use as a scooter is illustrated in FIG. 6 in which deflection of the handle assemblies 106 to the right causes a corresponding steering motion to be transferred through the pivot assembly and the steering linkage to the front wheel assemblies thereby causing the scooterbag 100R to turn toward the right. As also illustrated in FIG. 6, deflection of the handle assemblies 106 to the left causes a corresponding movement of the front wheel assemblies thereby causing the scooterbag 100L to turn toward the left. As will be appreciated by those skilled in the art, the scooterbag could also be configured for steering by shifting the rider's weight as used, for example, in conventional skateboard trucks, using the handle assemblies for support rather than steering input.

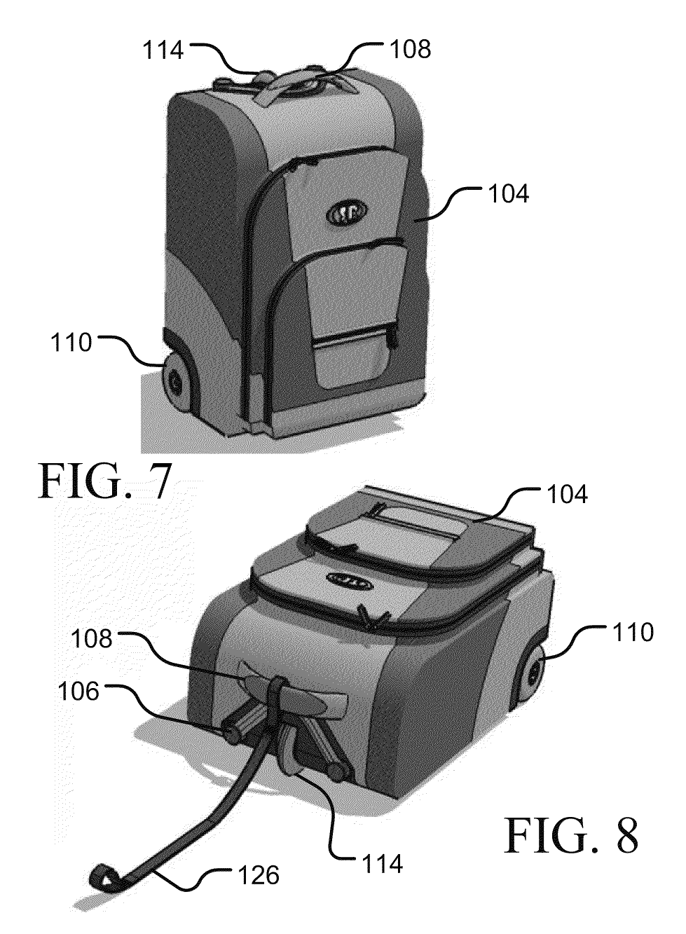

As illustrated in FIG. 7, the scooterbag as illustrated in FIGS. 1 and 2 may also be configured for use as a carry-on bag in which the deck is secured in a stowed position and the handle assemblies are retracted or stowed within corresponding recesses (not shown) provided in the primary frame and/or the bag assembly to reduce the overall dimensions of the scooterbag. As illustrated in FIG. 8, the scooterbag may also be configured to be pulled or towed in a more stable configuration once again utilizing the front wheel assemblies 110 and the rear wheel assembly 114 in combination with the primary frame to support the bag assembly 104. A strap or other handle 126 may then be attached to the conventional handle 108 or another suitable attachment point for towing the scooterbag in this configuration. Embodiments of the scooterbag may also incorporate a mechanism (not shown) for selectively locking the rear wheel assembly whereby the rear wheel can revolve freely when used in the towed position or locked to reduce movement when stowed as a carry-on bag. As will be appreciated by those skilled in the art, a variety of mechanisms can be utilized to achieve this functionality including, for example, a pin extending through a gap between adjacent wheel spokes or a sliding or rotating element that engages a complementary structure provided on the rear wheel or axel.

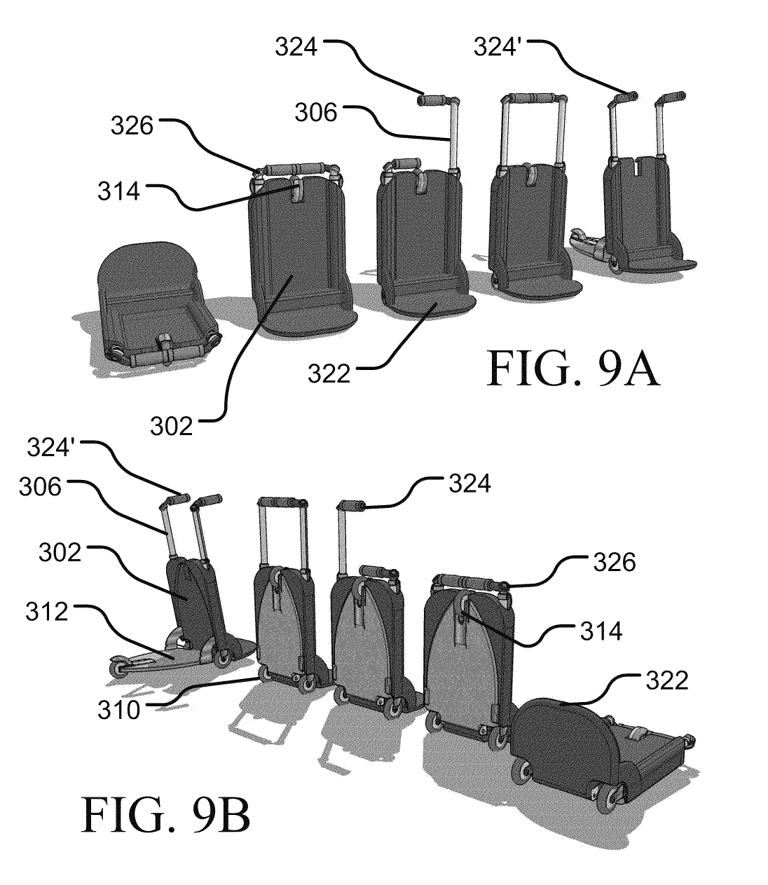

As illustrated in FIG. 9A, embodiments of the scooterbag may be converted between a carry-on configuration and a scooter configuration by lifting the scooterbag upright and extending one or both of the handle assemblies 306 either simultaneously or in sequence. When both handle assemblies are in a raised position, an apparatus provided in one or both of the handles, for example a sleeve or a rod assembly (not shown), may be utilized to engage the handle assemblies to form, at least temporarily, a conventional U-shaped or II-shaped handle that will allow the scooterbag to be utilized as a conventional rolling bag.

When the user desires to use the scooterbag as a scooter, each of the handle assemblies may be rotated whereby the handles 324′ will project for the front of the scooterbag. As will be appreciated by those skilled in the art, routing and the handle assemblies may involve rotating the entire shaft or, alternatively, rotating the handles relative to the shaft about a pivot assembly 326 provided near the top of the handle assembly. With the handles in this position, the user may utilize the modified grip position in order to shift the center of mass forward and thereby provide a more secure riding position. The handle assemblies may also be configured whereby the deck 312 is automatically released when the handles are rotated into the preferred riding position. As will be appreciated by those skilled in the art, a number of mechanisms may be utilized to achieve this operation including, for example, a cable activated catch cooperating with a corresponding structure provided on the deck, the hinge structure or the primary frame.

As illustrated in FIG. 9B, the scooterbag may be just as easily be converted from a scooter configuration to a carry-on configuration by returning the handle assemblies 306 to a rolling bag configuration, simultaneously or independently returning the handle assemblies to a stowed position within the primary frame 302 and returning the deck 312 to its stowed position at or within a rear surface of the primary frame. A latching or retaining mechanism will typically be engaged, either automatically or manually, as the deck is moved into a stowed position to maintain the stowed position until released by the user. One or more user accessible releases for the latching or retaining mechanism may be provided, for example, on the primary frame and/or integrated into the handle assemblies as desired.

As illustrated in FIGS. 3, 9A and 9B, embodiments of the scooterbag may be configured for receiving a separately purchased bag or backpack wherein the support or projection 222, 322, supports the additional bag and provides a range of attachment points and/or hardware for securing a range of bags to the primary frame and, in some instances, the projection. As will be appreciated by those skilled in the art, the range of auxiliary equipment that could be attached to appropriate embodiments of the scooterbag including, for example, skateboard bags, snow/boogie board carriers or other carriers or holders adapted to specific types of athletic and sports equipment.

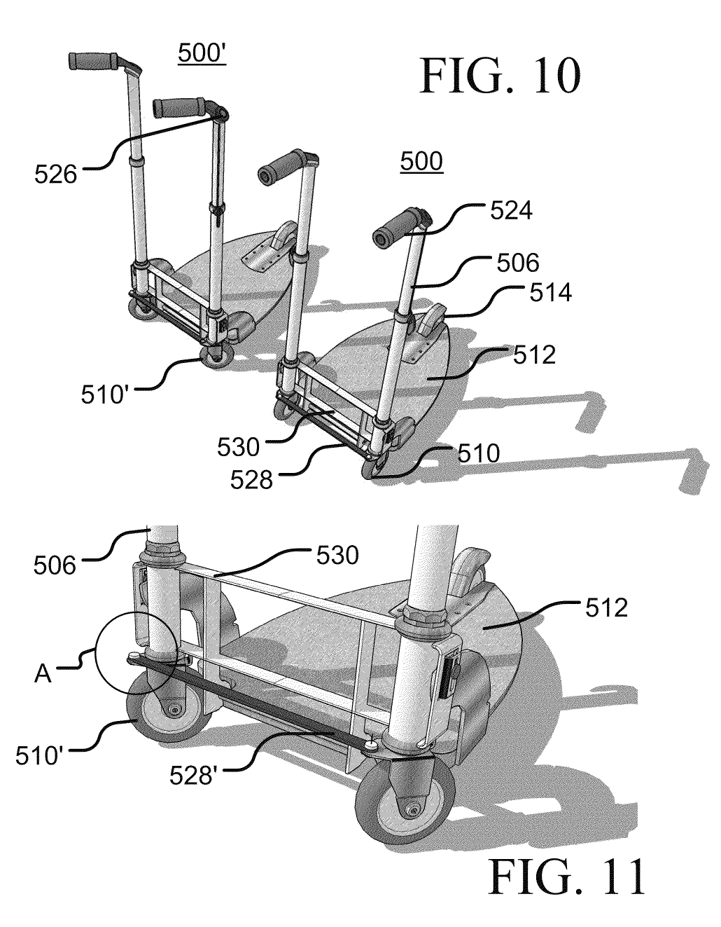

As illustrated in FIGS. 10 and 11, embodiments of the scooterbag may be provided with a steering mechanism that allows the direction of travel of the scooterbag to be controlled by the rider to provide, for example, travel in a forward direction 500 or more turned toward the right 500′ or the left (not shown). In the embodiment illustrated in FIGS. 10 and 11, a steering assembly 528 is provided for synchronizing the motion of the front wheel assemblies 510. As will be appreciated by those skilled in the art, a steering assembly is not be restricted to the illustrated position but may, for example, be provided at one or more locations along the handle assemblies. The range of motion provided for the off-center steering assembly 528′ may be limited by mechanical interference between the steering assembly and another portion of the scooterbag structure such as that illustrated in region A or with a portion of the reinforcing assembly 530. As will be appreciated by those skilled in the art, a range of alternative structures may be utilized to limit, for example, the range of motion allowed in the handle assemblies 506, the steering mechanism 528, 528′ and/or the front wheel assemblies 510, 510′.

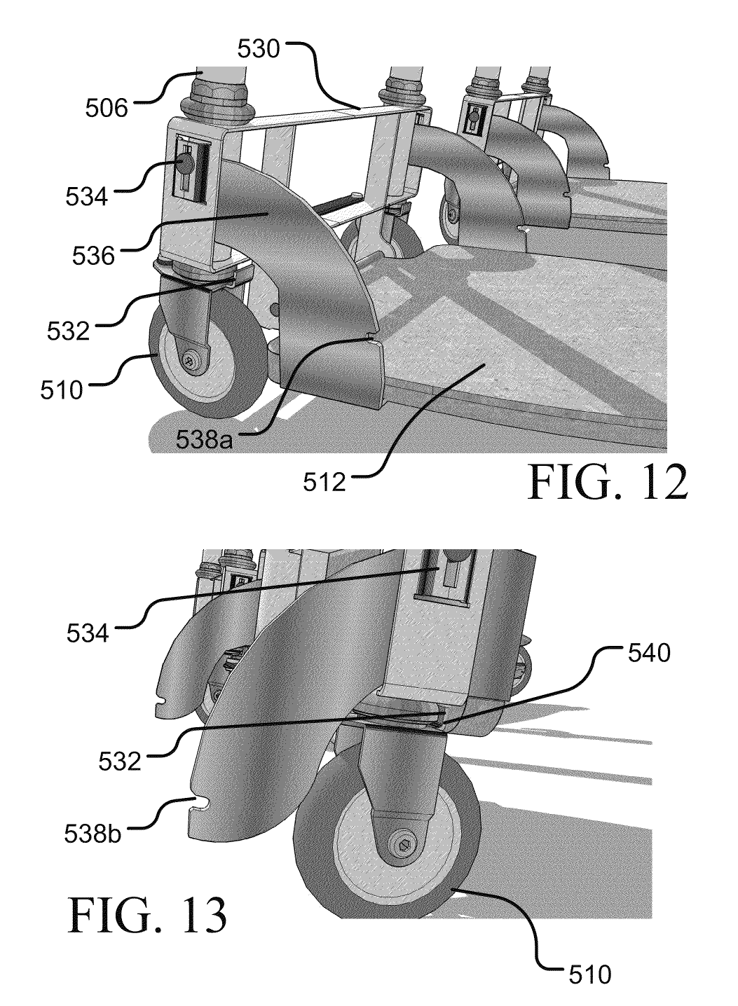

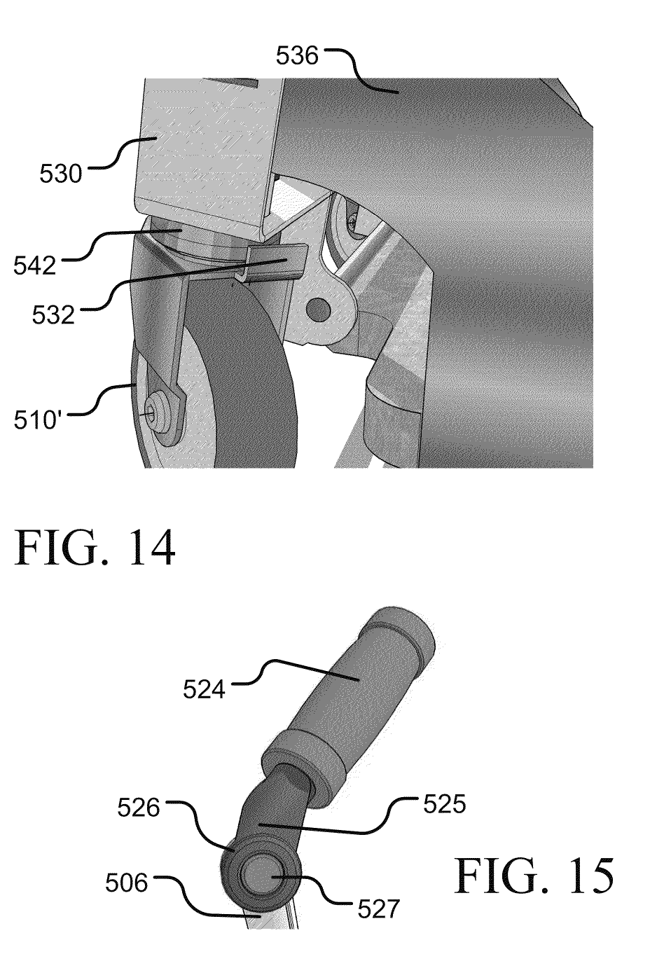

As illustrated in FIGS. 12-14, embodiments of the scooterbag may incorporate support members 536 for maintaining preferred orientations between the primary frame and the deck 512. The support members may be provided with one or more notches or detents 538a, 538b that can cooperate with a releasable holding assembly 534 for temporarily fixing the orientation of the deck relative to the primary frame and/or the handle assemblies 506. The deck may also be supported by a hinge assembly provided on a portion of the reinforcing assembly 530. The front wheel assemblies 510 may be provided with a projection, flange or tab 532 configured for cooperation with a corresponding structure, for example, a recess or pin, provided on the deck or the support members to fix the wheel assemblies in a straight orientation when the deck is in a stowed position thereby improving the operation of the scooterbag as a conventional wheeled bag. As will be appreciated by those skilled in the art, a wide range of release mechanisms may be provided on the scooterbag for selectively releasing and stowing the deck and/or extending, rotating and stowing the handle assemblies. Various actuators including, for example, levers, buttons, flanges and/or pull tabs may be provided at appropriate locations for operation by the user to aid in converting the scooterbag to a desired configuration or providing custom adjustments for one or more elements for adapting the scooterbag for a particular user's comfort or preference (e.g., handle height).

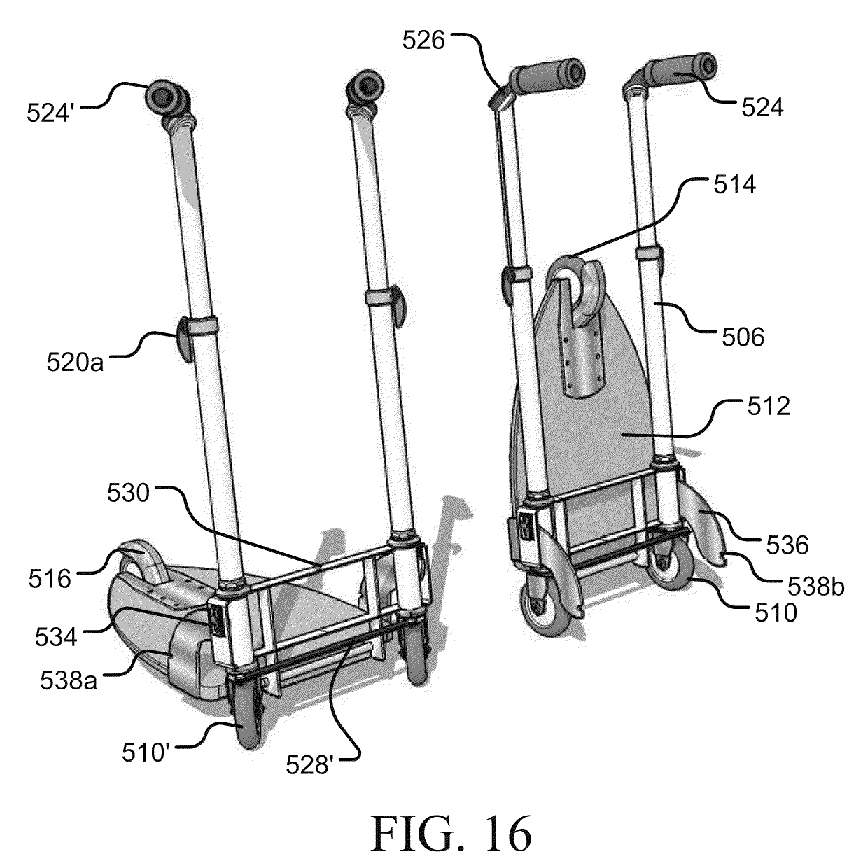

As illustrated in FIG. 15, the handle assemblies 506 may terminate in a structure including a pivot assembly 526, a handle support 525 and a handle or grip 524. The handle support and handle may be provided as distinct elements to simplify replacement or alteration of the handle at the discretion of the user to achieve a desired feel or color combination. As discussed above, the handle assemblies may be configured whereby rotation of the handle to the preferred scooter location also acts to release the deck from its stowed position utilizing, for example, a cable or other linkage for transferring the relative motion to catch mechanism. In the alternative, other catch assemblies can be provided for selectively securing and releasing the deck from its stowed position. The pivot assembly may also be provided with a release button 527 or equivalent mechanism that can be easily activated by the user in order to allow movement of the handle relative to the remainder of the handle assembly and/or for actuating other mechanisms provided on the scooterbag including, for example, one or more pivoting or locking assemblies.

As will be appreciated by those skilled in the art, the disclosed scooterbags could be modified in a variety of ways in order to modify the functional and/or aesthetic elements of the apparatus. Modifications and alterations may include, for example, incorporating a deck release assembly (not shown) with the handle assemblies whereby movement of the handle assemblies from the conventional wheeled luggage position to a scooter steering position would release the deck from its stowed position.

As will also be appreciated by those skilled in the art, there are a wide range of handles, releases, latches, brakes and locking mechanisms that could be successfully incorporated into the scooterbag assembly for controlling and/or coordinating the movement of the other elements. For example, the handle assemblies could incorporate telescoping elements for reducing the size of the recesses necessary to contain them in a carry-on orientation that may, in turn, increase the interior volume of the bag assembly and/or reduce the overall size. The wheel assemblies could also be modified to provide, for example, shock absorbers or other suspension elements for improving the quality of the scooter function. Similarly, the wheel assemblies could be linked to a small dynamo or generator that would generate electrical power while the wheels are in motion that could, in turn, be stored onboard in a capacitor, battery or other storage means. The user could then tap this reserve power to extend the useful period of a variety of personal electronics including, for example, MP3 players, cell phones and/or electronic game consoles.

Depending on target market and price point considerations, the scooterbag could also be provided with one or more motors for selectively driving one or more of the wheels to provide a self-propelled scooter configuration. As will be appreciated by those skilled in the art, such an adaptation would tend to increase the overall weight of the scooterbag and, consequently, would tend to limit its utility in a carry-on bag configuration and may complicate security screening procedures at transportation hubs.

The wheels may be configured for ease of replacement, thereby providing for alternate wheel configurations for use on various surfaces. The wheels could also be provided with lighting systems that, in turn, could vary with the rotational speed of the wheels in terms of color, brightness and/or flashing frequency. The scooterbag could also be wired to support a variety of personal electronics and thereby serve as, for example, a power source for charging external devices and/or as protective carrier for the electronics providing external ports for connection of audiovisual devices including, for example, earbuds or display devices.

While the invention has been particularly shown and described with reference to certain example embodiments thereof, it will be understood by those of ordinary skill in the art that various changes in form and details may be made therein without departing from the spirit and scope of the invention as disclosed above.

We claim:

1. A convertible scooterbag comprising:
a frame;
a receptacle provided on the frame;
a deck pivotally connected to the frame for movement between a stowed position and a deployed position;
a plurality of steerable wheel assemblies provided adjacent a forward portion of the deck and a single wheel assembly provided adjacent a rearward portion of the deck;
and a first handle assembly configured for movement between a stowed position and a deployed position relative to the frame.

2. The convertible scooterbag according to claim 1, further comprising:
a steering linkage arranged and configured to provide coordinated movement of the steerable wheel assemblies.

3. The convertible scooterbag according to claim 1, wherein:
the first handle assembly is arranged and configured for providing steering input to the steerable wheel assemblies.

4. The convertible scooterbag according to claim 1, further comprising:
a brake assembly arranged and configured for applying a braking force to the rear wheel assembly.

5. The convertible scooterbag according to claim 1, further comprising:
a second handle assembly configured for movement between a stowed position and a deployed position relative to the frame, the second handle assembly being moveable independently of the first handle assembly.

6. The convertible scooterbag according to claim 5, further comprising:
grip assemblies provided adjacent upper portions of the handle assemblies.

7. The convertible scooterbag according to claim 6, wherein:
the grip assemblies are configured for pivotal movement relative to the handle assemblies.

8. The convertible scooterbag according to claim 6, wherein:
the grip assemblies are configured for temporary connection to each other for forming a unitary grip.

9. The convertible scooterbag according to claim 1, further comprising:
releasable positioning assemblies arranged and configured for securing the deck in at least the stowed position and the deployed position relative to the frame.
